(19) United States
(12) Patent Application Publication
(10) Pub. No.: US 2025/0017331 A1
(43) Pub. Date: Jan. 16, 2025

(54) WATCH STRAP AND SMART WATCH INCLUDING THE SAME

(71) Applicant: SAMSUNG ELECTRO-MECHANICS CO., LTD.

(72) Inventors: Seyeon Hwang, Suwon-si, Gyeonggi-do (KR); Han Kim, Suwon-si, Gyeonggi-do (KR); Seungjae Song, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/279,701

(22) PCT Filed: Jul. 4, 2023
(86) PCT No.: PCT/KR2023/009411

§ 371 Date: Aug. 31, 2023

(30) Foreign Application Priority Data
Mar. 30, 2023 (KR) 10-2023-0041942

(51) Int. Cl. A44C 5/10; A44C 5/14; G04G 17/04; H01M 50/503; H01M 50/512

(52) U.S. Cl. CPC A44C 5/107; A44C 5/147; H01M 50/503; H01M 50/512; G04G 17/045; H01M 2220/30

(57) ABSTRACT

A watch strap and a smart watch includes: a plurality of strap blocks arranged consecutively in one direction; and a plurality of hinge coupling units pivotably coupled to both sides of the plurality of strap blocks to integrally connect the plurality of strap blocks to each other. An all-solid-state battery having electrode terminal units on both sides thereof is embedded in at least one of the plurality of strap blocks. At least one of the plurality of hinge coupling units is electrically connected to one of the electrode terminal units.

### TECHNICAL FIELD

The present disclosure relates to a watch strap and a smart watch including the same.

### BACKGROUND ART

Recently, healthcare wearable devices having various functions have been used, and a representative one among them is a smart watch. The smart watch has various functions such as measuring changes in the body during exercise and exercise records, and measuring and analyzing the user's physical conditions such as the number of steps, a heart rate, and a stress index during daily life. Therefore, unlike general watches, more and more users spend all their times with smart watches, even during exercising, showering, and sleeping.

A lithium ion battery may be used as a battery of the smart watch. The lithium ion battery may be deformed at high temperatures or by an impact. In order to prevent the battery from being damaged by a structure contacting the battery, which may result in problems of breakage or explosion, it is necessary to secure a sufficient space for mounting the battery. However, the size of the head of the smart watch is limited, and accordingly, the battery installation space is also limited.

Moreover, as the smart watch has been developed to have more functions, the number of parts installed inside the head increases, limiting the battery installation space and shortening the battery lasting time due to faster battery consumption. Since a conventional smart watch needs to perform various functions with a limited battery capacity as described above, the usable time of the smart watch is short, resulting in in-convenience in that the smart watch needs to be charged frequently.

### DISCLOSURE OF INVENTION

### Technical Problem

The present disclosure attempts to provide a watch strap and a smart watch including the same capable of increasing the battery lasting time and the useable time of the smart watch without expanding a space for installing a battery in a head of the smart watch

However, the problem to be solved by the embodiments of the present disclosure is not limited to the above-described problem and may variously extend within the scope of the technical idea covered by the present disclosure.

### Solution to Problem

An embodiment of the present disclosure provides a watch strap including: a plurality of strap blocks arranged consecutively in one direction; and a plurality of hinge coupling units pivotably coupled to both sides of the plurality of strap blocks to integrally connect the plurality of strap blocks to each other. An all-solid-state battery having electrode terminal units on both sides thereof is embedded in at least one of the plurality of strap blocks. At least one of the plurality of hinge coupling units is electrically connected to one of the electrode terminal units.

The all-solid-state battery may include a battery body. The battery body may include a solid electrolyte, a first electrode located on one side of the solid electrolyte, and a second electrode located on the other side of the solid electrolyte. The electrode terminal units, such as first and second terminal units, may be located on both sides of the battery body, respectively. Each of the electrode terminal units may include a terminal plate and two terminal protrusions, such as first and second terminal protrusions, fixed to the terminal plate. The two terminal protrusions, such as first and second terminal protrusions, may be located at a distance from each other in the one direction.

The all-solid-state battery may be surrounded by a battery case. The battery case may include a body case surrounding the battery body, and a terminal case surrounding the electrode terminal unit and detachably coupled to the body case.

The hinge coupling unit may include a hinge plate and two hinge shafts, such as first and second hinge shafts, fixed to the hinge plate. The hinge plate may face the two electrode terminal units adjacent to each other in the one direction. The two hinge shafts may be pivotably coupled to a terminal protrusion of one of the two electrode terminal units and a terminal protrusion of the other of the two electrode terminal units adjacent to the one electrode terminal unit, respectively, to be electrically connected to the two terminal protrusions coupled thereto. The hinge coupling unit may be surrounded by a hinge case except for the two hinge shafts.

The all-solid-state battery may be embedded in each of the plurality of strap blocks, and the plurality of all-solid-state batteries may be arranged in such a manner that the first electrodes are located on the same side. Each of the plurality of hinge coupling units may be electrically connected to the two electrode terminal units adjacent to each other in the one direction. The plurality of all-solid-state batteries may be connected in parallel to each other by the plurality of hinge coupling units.

The watch strap may further include a fastening block having a pair of connection terminals therein. At least one of the plurality of hinge coupling units may be pivotably coupled to both the electrode terminal unit of one of the plurality of strap blocks and the fastening block to electrically connect one of the pair of connection terminals and the electrode terminal unit.

Another embodiment of the present disclosure provides a smart watch including: (i) a watch head including a display unit and a power supply unit; and (ii) watch straps coupled to both sides of the watch head to be worn on a user's wrist. Each of the watch straps includes: a plurality of strap blocks arranged consecutively in one direction; and a plurality of hinge coupling units pivotably coupled to both sides of the plurality of strap blocks to integrally connect the plurality of strap blocks to each other. An all-solid-state battery having electrode terminal units on both sides thereof is embedded in at least one of the plurality of strap blocks. At least one of the plurality of hinge coupling units is electrically connected to one of the electrode terminal units and the power supply unit.

The all-solid-state battery may include a first electrode, a solid electrolyte, and a second electrode. The all-solid-state battery may be embedded in each of the plurality of strap blocks. The plurality of all-solid-state batteries may be arranged in such a manner that the first electrodes are located on the same side. Each of the plurality of hinge coupling units may be electrically connected to the two electrode terminal units adjacent to each other in the one direction. The plurality of all-solid-state batteries may be connected in parallel to each other by the plurality of hinge coupling units.

Each of the electrode terminal units may include two terminal protrusions, and each of the hinge coupling units may include two hinge shafts. The two hinge shafts may be pivotably coupled to a terminal protrusion of one of the two electrode terminal units adjacent to each other in the one direction and a terminal protrusion of the other of the two electrode terminal units adjacent to the one electrode terminal unit, respectively, to electrically connect the two terminal protrusions coupled thereto to each other.

The watch head may include a support having an internal space for accommodating the display unit and the power supply unit. A plurality of flanges may be located on both sides of the support, and the support may expose a pair of input terminals electrically connected to the power supply unit.

The plurality of flanges may be a pair of flanges, and the pair of input terminals may be located between the pair of flanges on a side surface of the support. The watch strap may further include a fastening block coupled to the pair of flanges between the pair of flanges. The fastening block may include a pair of connection terminals electrically connecting the pair of input terminals and the all-solid-state battery to each other.

The pair of connection terminals may be located inside the fastening block, and respective first ends of the pair of connection terminals may be exposed to both sides of the fastening block. Respective second ends of the pair of connection terminals are exposed to an inner surface of the fastening block facing the support to be connected to the pair of input terminals. At least one of the plurality of hinge coupling units may be pivotably coupled to both the electrode terminal unit of one of the plurality of strap blocks and one of the first ends to electrically connect the electrode terminal unit and the first end to each other.

In another aspect, the plurality of flanges may include a central flange and two side flanges. The pair of input terminals may be located on both sides of the central flange. Among the plurality of hinge coupling units, two hinge coupling units may be coupled to the central flange and the side flanges in recess portions between the central flange and the side flanges. Each of the two hinge coupling units may be coupled to the electrode terminal unit of one of the plurality of strap blocks and one of the input terminals to electrically connect the electrode terminal unit and the input terminal to each other.

### Advantageous Effects of Invention

The smart watch according to an embodiment is capable of operating by receiving power from not only the built-in battery accommodated in the watch head but also the all-solid-state batteries accommodated in the watch straps. Therefore, the smart watch according to an embodiment is capable of increasing the battery life and the usage time, and increasing the charging cycle, thereby increasing user convenience.

### BRIEF DESCRIPTION OF DRAWINGS

FIG. 1 is a perspective view of a smart watch according to an embodiment.

FIG. 2 is a block diagram for explaining operations of the smart watch illustrated in FIG. 1.

FIG. 3 is an exploded perspective view of a support and a watch strap of the smart watch illustrated in FIG. 1.

FIG. 4 is an exploded perspective view of the watch strap of the smart watch illustrated in FIG. 1.

FIG. 5 is an exploded perspective view of a terminal case and a hinge coupling unit of the watch strap illustrated in FIG. 4.

FIG. 6 is a perspective view of a coupled state between an all-solid-state battery and the hinge coupling unit of the watch strap illustrated in FIG. 4.

FIG. 7 is a perspective view of a smart watch according to another embodiment.

FIG. 8 is an exploded perspective view of the smart watch illustrated in FIG. 7.

### MODE FOR THE INVENTION

Hereinafter, embodiments of the present disclosure will be described in detail with reference to the accompanying drawings so that they can be easily carried out by those of ordinary skill in the art to which the present disclosure pertains. In order to clearly describe the present disclosure, parts irrelevant to the description are omitted in the drawings, and the same or similar components will be denoted by the same reference signs throughout the specification. In the accompanying drawings, some components are exaggerated, omitted, or schematically illustrated, and a size of each component does not entirely reflect the actual size.

The accompanying drawings are provided only to help easily understand the embodiments disclosed in the present specification, and it should be understood that the technical spirit disclosed in the present specification is not limited by the accompanying drawings, and the present disclosure includes all modifications, equivalents, and substitutions falling within the spirit and the technical scope of the present disclosure.

Terms including ordinal numbers such as first and second may be used to describe various components, but these components are not limited by these terms. These terms are used only for the purpose of distinguishing one component from another component.

In addition, when a part such as a layer, a film, a region, or a plate is referred to as being “on” another part, it may be “directly on” another part or there may be an intervening part therebetween. In contrast, when a part is referred to as being “directly on” another part, there is no intervening part therebetween. In addition, when a part is referred to as being “on” a reference part, this means that the part is located on or under the reference part, and does not necessarily mean that the part is located “on” the reference part in the opposite direction of gravity.

It should be understood that terms “include,” “have,” and the like used throughout the specification specify the presence of features, numerals, steps, operations, components, parts, or combinations thereof mentioned in the specification, but do not preclude the presence or addition of one or more other features, numerals, steps, operations, components, parts, or combinations thereof. Therefore, when a certain part is referred to as “including” a certain component, this implies the presence of other components, not precluding the presence of other components, unless explicitly stated to the contrary.

In addition, throughout the specification, the phrase “in a plan view” means when a target part is viewed from above, and the phrase “in a cross-sectional view” means when a cross section of a target part as vertically cut is viewed laterally.

In addition, throughout the specification, the expression “connected” means that two or more components are connected to each other not only in a direct manner but also in an indirect manner through another component, means that two or more component are connected to each other not only physically but also electrically, or means that two or more components are integrally formed even though they are referred to by different terms based on their positions and functions.

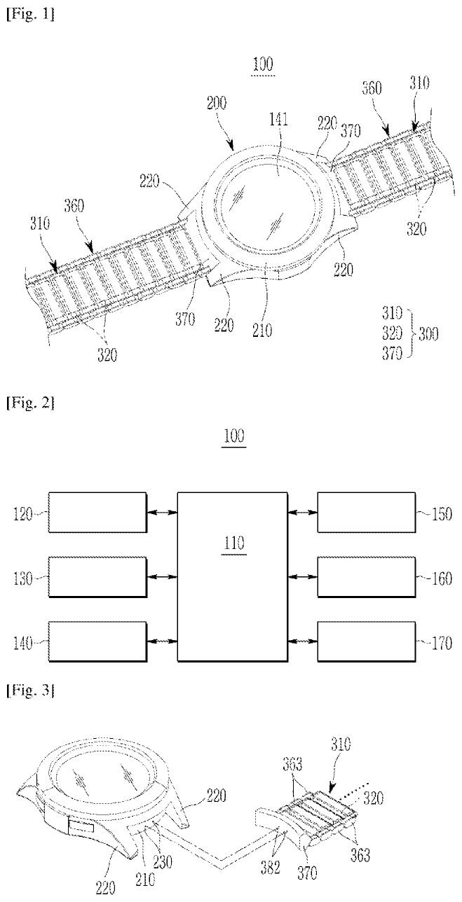

FIG. 1 is a perspective view of a smart watch according to an embodiment.

Referring to FIG. 1, a smart watch 100 according to an embodiment includes a watch head 200 where a display unit 141 is located, and watch straps 300 coupled to both sides of the watch head 200. The watch straps 300 are flexible and may be bent to fit the user's wrist. An all-solid-state battery 320 to be described below may be embedded in the watch strap 300 worn on the user's wrist.

FIG. 2 is a block diagram for explaining operations of the smart watch illustrated in FIG. 1.

Referring to FIG. 2, the smart watch 100 may include a control unit 110, a wireless communication unit 120, an input unit 130, an output unit 140, an interface unit 150, a memory 160, and a power supply unit 170. The block diagram illustrated in FIG. 2 is merely an example, and other components may be added or at least one of the components illustrated in FIG. 2 may be omitted.

The wireless communication unit 120 may include one or more modules enabling the smart watch to perform wireless communication with another electronic device, a wireless communication system, an external server, one or more networks, and the like. The wireless communication unit 120 may include at least one of a mobile communication module, a wireless Internet module, a short-distance communication module, and a broadcast reception module.

The input unit 130 may include a user input unit for inputting user information, an image input unit for inputting an image signal, an audio input unit for inputting an audio signal, and the like. The user input unit may include at least one of a touch screen, mechanical buttons, and mechanical dials. The image input unit may include a camera, and the audio input unit may include a microphone.

The output unit 140 may include a display unit 141 for outputting visual information, a sound output unit for outputting auditory information, and a haptic module for outputting a tactile signal. The display unit 141 may be a display panel with a built-in touch screen, and the sound output unit may include a speaker.

The interface unit 150 enables connection between the smart watch 100 and other external devices. For example, the interface unit 150 may include a wired/wireless headset port, a wired/wireless earphone port, an external charger port, a wired/wireless data port, an audio input/output port, a video input/output port, a memory card port, and the like.

The memory 160 may store a plurality of application programs running in the smart watch 100, and data and commands for operating the smart watch 100. The control unit 110 may control overall operations of the smart watch 100 and operations of the application programs. The control unit 110 may process input/output information of the smart watch 100, run the application programs stored in the memory 160, and provide appropriate information to the user.

The power supply unit 170 may supply power to components included in the smart watch 100 from an external power source or an internal power source. The external power source may be external power supplied through an external charger, and the internal power source may include a battery. The battery may include a built-in battery mounted on the watch head 200 (see FIG. 1) and an all-solid-state battery 320 built in the watch strap 300 (see FIG. 1).

Referring back to FIG. 1, the watch head 200 may include a display unit 141 and a support 210 coupled to the display unit 141. The support 210 may have an internal space, and may accommodate the display unit 141, the built-in battery, and various components in the internal space. The display unit 141 is fixed at a foremost position of the internal space of the support 210 so that a front surface thereof is exposed to the outside, and the built-in battery and the various components may be located behind the display unit 141.

A plurality of flanges to be coupled to the watch strap 300 may be located on both sides of the support 210. For example, a pair of flanges 220 may protrude from each side of the support 210, and one end of the watch strap 300 may be mechanically coupled to the pair of flanges 220 by inserting between the pair of flanges 220. The watch strap 300 may include a conventional buckle.

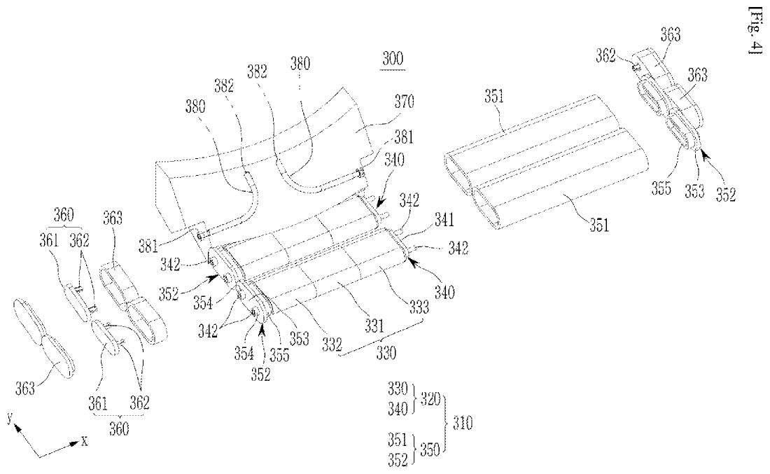

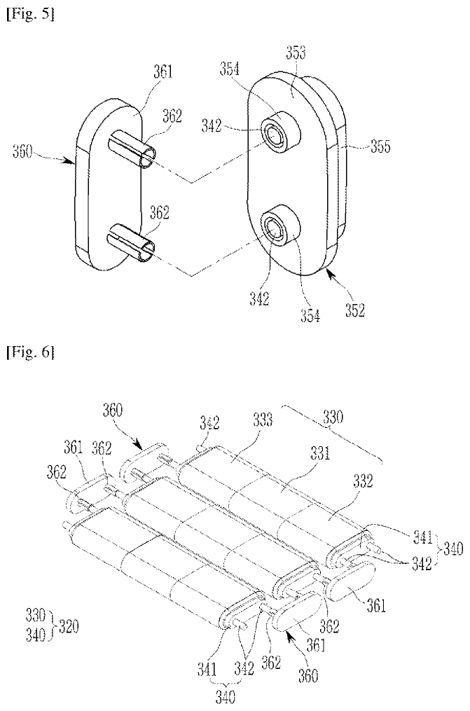

FIG. 3 is an exploded perspective view of the support 210 and the watch strap 300 of the smart watch illustrated in FIG. 1. FIG. 4 is an exploded perspective view of the watch strap of the smart watch illustrated in FIG. 1. FIG. 5 is an exploded perspective view of a terminal case and a hinge coupling unit of the watch strap illustrated in FIG. 4. FIG. 6 is a perspective view of a coupled state between the all-solid-state battery 320 and the hinge coupling unit 360 of the watch strap illustrated in FIG. 4.

Referring to FIGS. 3 to 6, the watch strap 300 may include a plurality of strap blocks 310 arranged consecutively in one direction, and a plurality of hinge coupling units 360 pivotably coupled to both sides of the plurality of strap blocks 310 to integrally connect the plurality of strap blocks 310 to each other. In addition, the watch strap 300 may include a fastening block 370 connecting the support 210 and the plurality of strap blocks 310 to each other.

The fastening block 370 may be coupled to one of the plurality of the strap blocks 310 positioned closest to the support 210 among the plurality of strap blocks 310 by a pair of hinge coupling units 360. The fastening block 370 may be located between the pair of flanges 220 and mechanically coupled to the pair of flanges 220 using fastening means such as screws. However, this fastening configuration is merely an example, and the fastening block 370 and the pair of flanges 220 may be coupled to each other in various ways.

An all-solid-state battery 320 having electrode terminal units 340 on both sides thereof may be embedded in at least one of the plurality of strap blocks 310. In some embodiments, the all-solid-state battery 320 includes first and second electrode terminal units 340 on two side surfaces of the all-solid-state battery 320, respectively. Also, at least one of the plurality of hinge coupling units 360 may be electrically connected to the electrode terminal units 340 of the all-solid-state battery 320. For example, all-solid-state batteries 320 may be embedded in all of the plurality of strap blocks 310, and all of the plurality of hinge coupling unit 360 may be electrically connected to the electrode terminal units 340 of the all-solid-state batteries 320.

The strap block 310 may include an all-solid-state battery 320 and a battery case 350 surrounding the all-solid-state battery 320. The all-solid-state battery 320 may include a battery body 330 and electrode terminal units 340 positioned on both sides of the battery body 330. The battery body 330 may include a solid electrolyte 331 and a first electrode 332 and a second electrode 333 located with the solid electrolyte 331 in-terposed therebetween. The first electrode 332 may be a positive electrode, and the second electrode 333 may be a negative electrode. In some embodiments, the first electrode terminal unit 340 is located on one side surface of the first electrode, which is not in contact with the solid electrode, and the second electrode terminal unit 340 is located on one side surface of the second electrode, which is not in contact with the solid electrode.

The solid electrolyte 331 functions as a medium for transferring ions between the first electrode 332 and the second electrode 333. For example, the solid electrolyte 331 may include at least one of a garnet type solid electrolyte, a Lithium super ionic conductor (LiSICON) type solid electrolyte, a perovskite type solid electrolyte, and a sodium (Na) super ionic conductor (NaSICON) type solid electrolyte.

The battery body 330 may have a substantially rectangular parallelepiped shape, and the first electrode 332, the solid electrolyte 331, and the second electrode 333 may be sequentially positioned in a longitudinal direction of the battery body 330 (x direction in FIG. 4). Since the all-solid-state battery 320 uses the solid electrolyte instead of a liquid electrolyte, the all-solid-state battery 320 is less likely to be deformed by external impacts and can operate stably even in harsh environments of high tem-perature and high pressure.

The electrode terminal unit 340 may include a terminal plate 341 and two terminal protrusions 342, such as first and second terminal protrusions 342, projecting outwardly from the terminal plate 341. The two terminal protrusions 342 may be positioned at a distance from each other in a longitudinal direction of the watch strap 300 (y direction in FIG. 4). The two electrode terminal units 340 may attach to side surface of the all-solid-state battery 320 and face each other in a longitudinal direction (x direction in FIG. 4) of the all-solid-state battery 320 with the battery body 330 in-terposed therebetween.

The battery case 350 may include a body case 351 surrounding the battery body 330 and a terminal case 352 surrounding the electrode terminal unit 340.

The body case 351 may be hollow and open on both sides. The terminal case 352 may include a plate cover 353 covering the terminal plate 341, two protrusion covers 354 surrounding the two terminal protrusions 342 respectively, and a fitting protrusion 355 inserted into the body case 351 and fitted into the body case 351. The body case 351 and the terminal case 352 may be detachably coupled to each other. A prede-termined gap may exist between the terminal protrusion 342 and the protrusion cover 354.

Among the components of the all-solid-state battery 320 in the strap block 310, the four terminal protrusions 342 may be exposed to the outside in which two terminal protrusions 342 exposed outside on each of the side surfaces of the all-solid-state battery 320, and the other components may be accommodated inside the battery case 350. The plurality of all-solid-state batteries 320 may be arranged consecutively in one direction in such a manner that the first electrodes 332 are located on the same side and the second electrodes 333 are located on the same side inside the plurality of battery cases 350.

The hinge coupling units 360 may be located on both sides of two adjacent strap blocks 310, and may be coupled to the two adjacent strap blocks 310. The hinge coupling unit 360 may include a hinge plate 361 and two hinge shafts 362, such as first and second hinge shafts 363, fixed to the hinge plate 361. The hinge shaft 362 may have a shape like a hollow tube and may be fitted into the gap between the terminal protrusion 342 and the protrusion cover 354. The hinge shaft 362 may be electrically connected to the terminal protrusion 342 by contacting the terminal protrusion 342, and the terminal protrusion 342 and the hinge shaft 362 may rotate relative to each other.

The hinge plate 361 may face two adjacent strap blocks 310, and the two hinge shafts 362, such as first and second hinge shafts 362, may be coupled to the terminal protrusion 342 of one strap block 310 and the terminal protrusion 342 of the other strap block 310 adjacent thereto. That is, the hinge coupling unit 360 may connect two all-solid-state batteries 320 embedded in the two adjacent strap blocks 310 in parallel to each other. In some embodiments, each of the first and second electrode terminal units 340 includes first and second terminal protrusions 342, the first hinge shaft 362 is pivotally coupled to the second terminal protrusion of one of two of the first electrode terminal units 340 adjacent to each other or one of two of the second electrode terminal units 340 adjacent to each other, and the second hinge shaft 362 is pivotally coupled to the first terminal protrusion of one of two of the first electrode terminal units 340 adjacent to each other or one of two of the second electrode terminal units 340 adjacent to each other. Therefore, the plurality of all-solid-state batteries 320 may be connected to each other in such a manner that the first electrodes 332 are electrically connected to each other and the second electrodes 333 are electrically connected to each other by the plurality of hinge coupling unit 360.

The hinge plate 361 and the two hinge shafts 362 may be surrounded by a hinge case 363. Two openings may be located in the hinge case 363 to expose the two hinge shafts 362, respectively.

The hinge coupling units 360 may be located on both sides of the fastening block 370 and the strap block 310 to couple the fastening block 370 and the strap block 310 to each other. Here, a pair of connection terminals 380 may be located inside the fastening block 370, and first ends 381 of the connection terminals 380 may be exposed on both sides of the fastening block 370. The two hinge shafts 362 provided in the hinge coupling unit 360 may be coupled to the first end 381 of the fastening block 370 and the terminal protrusion 342 of the strap block 310 to electrically connect the all-solid-state battery 320 and the connection terminal 380 to each other.

In addition, second ends 382 of the connection terminals 380 may be exposed to an inner surface of the fastening block 370 facing the support 210, and a pair of input terminals 230 may be located on an outer circumferential surface of the support 210 facing the fastening block 370. The pair of input terminals 230 may be electrically connected to the power supply unit 170 (see FIG. 2), and may be connected to the pair of second ends 382 when the support 210 and the fastening block 370 are coupled to each other. Therefore, the plurality of all-solid-state batteries 320 may be electrically connected to the power supply unit 170 through the plurality of hinge coupling units 360, the pair of connection terminals 380, and the pair of input terminals 230.

Referring back to FIGS. 1 and 2, the smart watch 100 according to the embodiment can operate by receiving power from the all-solid-state batteries 320 accommodated in the watch strap 300 together with the built-in battery accommodated in the support 210. The all-solid-state battery 320 is suitable to be embedded in the watch strap 300 that comes into direct contact with the user's skin, because it is a safe battery that does not leak due to external shock or expansion.

Therefore, compared to a conventional smart watch that only uses a built-in battery, the smart watch 100 according to the present embodiment can increase the battery duration and the use time of the smart watch 100 and increase the number of charging cycles to maximize user convenience.

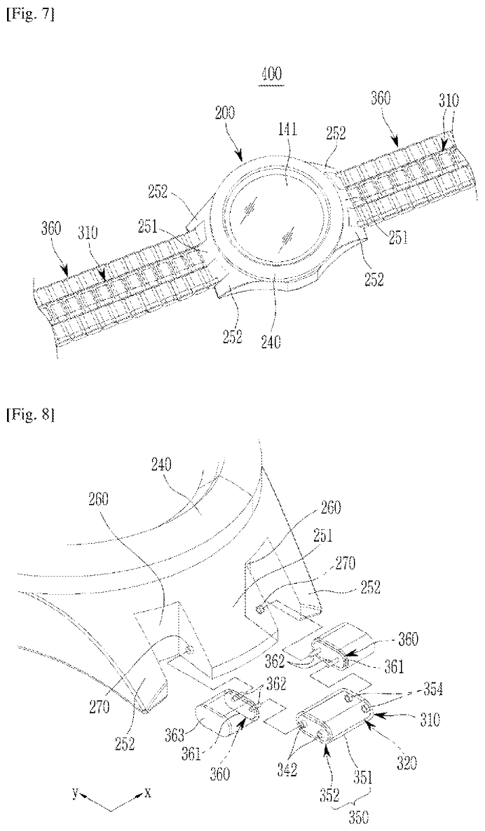

FIG. 7 is a perspective view of a smart watch according to another embodiment. FIG. 8 is an exploded perspective view of the smart watch illustrated in FIG. 7.

Referring to FIGS. 7 and 8, the smart watch 400 according to the present embodiment may have the same basic configuration as the smart watch 100 according to an embodiment described with reference to FIGS. 1 to 6, except that the fastening block 370 is omitted and the hinge coupling units 360 are directly coupled to the support 240.

In the smart watch 400 according to the present embodiment, three flanges may be located on both sides of the support 240. The three flanges may include a central flange 251 and side flanges 252 positioned on both sides of the central flange 251. A recess portion 260 may be located between the central flange 251 and each of the side flanges 252.

A plurality of strap blocks 310 in which all-solid-state batteries 320 are embedded may face the central flange 251, and may be arranged consecutively in one direction. A plurality of hinge coupling units 360 surrounded by respective hinge cases 363 may face the two recess portions 260 and may be arranged consecutively in one direction. Among the plurality of hinge coupling units 360, a hinge coupling unit 360 positioned closest to the support 240 may be coupled to the support 240 in the recess portion 260.

Specifically, the hinge coupling units 360 may be accommodated in the recess portions 260, and may be mechanically coupled to the central flange 251 and the side flanges 252 using fastening means such as screws. Also, input terminals 270 may be located on both sides of the central flange 251. One of the two hinge shafts 362 provided in the hinge coupling unit 360 may be coupled to the terminal protrusion 342 of the strap block 310, and the other may be coupled to the input terminal 270 to be electrically connected the input terminal 270.

The input terminals 270 of the central flange 251 may be electrically connected to the power supply unit 170 (see FIG. 2). The plurality of all-solid-state batteries 320 may be connected in parallel to each other by the plurality of hinge coupling units 360, and may be electrically connected to the power supply unit 170 (see FIG. 2) through the plurality of hinge coupling units 360 and the pair of input units 270.

In the smart watch 400 according to the present embodiment, a length of the hinge case 363 measured in a longitudinal direction of the all-solid-state battery 320 (x direction in FIG. 8) may be about 0.5 times or more and less than 1 time of a length of the strap block 310. Here, the plurality of hinge cases 363 may appear to comprise three rows of blocks together with the plurality of strap blocks 310.

Although the embodiments of the present disclosure have been described above, the present disclosure is not limited thereto, and various modifications may be made within the scope of the claims, the specification, and the accompanying drawings, which also fall within the scope of the present disclosure.

1. A watch strap comprising:
a plurality of strap blocks arranged consecutively in one direction;
a plurality of hinge coupling units pivotably coupled to both sides of each of the plurality of strap blocks to integrally connect the plurality of strap blocks to each other;
an all-solid-state battery embedded in at least one of the plurality of strap blocks; and
first and second electrode terminal units attached to both sides of the all-solid-state battery,
wherein at least one of the plurality of hinge coupling units is electrically connected to one of the first and second electrode terminal units.

2. The watch strap of claim 1, wherein
the all-solid-state battery includes a battery body,
the battery body includes a solid electrolyte, a first electrode located on one side of the solid electrolyte, and a second electrode located an opposite side of the solid electrolyte, and
the first electrode terminal unit is located on one side of the first electrode, which is not in contact with the solid electrode, and
the second electrode terminal unit is located on one side of the second electrode, which is not in contact with the solid electrode.

3. The watch strap of claim 2, wherein
each of the first and second electrode terminal units includes a terminal plate and first and second terminal protrusions fixed to the terminal plate, and
the first and second terminal protrusions are located at a distance from each other.

4. The watch strap of claim 3, wherein
the all-solid-state battery is surrounded by a battery case, and
the battery case includes a body case surrounding the battery body, and
a terminal case surrounding at least one of the first and second electrode terminal units and detachably coupled to the body case.

5. The watch strap of claim 3, wherein
each of the plurality of hinge coupling units includes a hinge plate and first and second hinge shafts fixed to the hinge plate, and
each of the plurality of hinge coupling units faces two of the first or second electrode terminal units adjacent to each other in the one direction.

6. The watch strap of claim 5, wherein
each of the first and second electrode terminal units includes first and second terminal protrusions,
the first hinge shaft is pivotably coupled to the second terminal protrusion of one of the two of the first or second electrode terminal units adjacent to each other,
the second hinge shaft is pivotably coupled to the first terminal protrusion of the other one of the two of the first or second electrode terminal units adjacent to each other, and
the first and second hinge shafts electrically connect the two of the first or second electrode terminal units adjacent to each other.

7. The watch strap of claim 5, wherein
at least one the plurality of hinge coupling unit is surrounded by a hinge case except for the first and second hinge shafts.

8. The watch strap of claim 2, wherein
the watch strap includes a plurality of the all-solid-state batteries, each of the plurality of the all-solid-state batteries is embedded in each of the plurality of strap blocks, and
the plurality of the all-solid-state batteries are arranged in such a manner that the first electrodes are located on the same side.

9. The watch strap of claim 8, wherein
each of the plurality of hinge coupling units is electrically connected to the two of the first electrode terminal units adjacent or two of the second electrode terminal units to each other in the one direction, and
the plurality of the all-solid-state batteries are connected in parallel to each other by the plurality of hinge coupling units.

10. The watch strap of claim 9, further comprising
a fastening block having a pair of connection terminals therein,
wherein at least one of the plurality of hinge coupling units is pivotably coupled to one of the first and second electrode terminal units and the fastening block to electrically connect the pair of connection terminals of the one of the first and second electrode terminal units and the one of the first and second electrode terminal unit.

11. A smart watch comprising
a watch head including a display unit and a power supply unit; and
watch straps coupled to both sides of the watch head to be worn on a user's wrist,
each of the watch straps includes:
a plurality of strap blocks arranged consecutively in one direction;
a plurality of hinge coupling units pivotably coupled to both sides of each of the plurality of strap blocks to integrally connect the plurality of strap blocks to each other;
an all-solid-state battery embedded in one of the plurality of strap blocks; and
first and second electrode terminal units attached to both sides of the all-solid-state battery,
wherein at least one of the plurality of hinge coupling units is electrically connected to one of the electrode terminal units and the power supply unit.

12. The smart watch of claim 11, wherein
the smart watch includes a plurality of the all-solid-state batteries,
each of the plurality of the all-solid-state batteries includes a first electrode, a solid electrolyte, and a second electrode,
each of the plurality of the all-solid-state batteries is embedded in one of the plurality of strap blocks, and
the plurality of the all-solid-state batteries are arranged in such a manner that the first electrodes are located on the same side.

13. The smart watch of claim 12, wherein
the first electrode terminal unit is attached to the first electrode,
the second electrode terminal unit is attached to the second electrode,
each of the plurality of hinge coupling units is electrically connected to two of the first electrode terminal units adjacent to each other in the one direction, or two of the second electrode terminal units adjacent to each other in one direction, and
the plurality of the all-solid-state batteries are connected in parallel to each other by the plurality of hinge coupling units.

14. The smart watch of claim 13, wherein
each of the first and second electrode terminal units includes the first and second terminal protrusions,
each of the plurality of hinge coupling units includes first and second hinge shafts, and
the first hinge shaft is pivotably coupled to the second terminal protrusion of one of two the first electrode terminal units adjacent to each other in the one direction or two of the second electrode terminal units adjacent to each other,
the second hinge shaft is pivotably coupled to the first terminal protrusion of one of two of the first electrode terminal units adjacent to each other in the one direction or two of the second electrode terminal units adjacent to each other
the first and second hinge shafts electrically connect the two of the first and second terminal protrusions adjacent to each other.

15. The smart watch of claim 11, wherein
the watch head includes a support having an internal space for accommodating the display unit and the power supply unit,
a plurality of flanges is located on both sides of the support, and
the support exposes a pair of input terminals electrically connected to the power supply unit.

16. The smart watch of claim 15, wherein
the plurality of flanges comprises a pair of flanges,
the pair of input terminals is located between the pair of flanges on a side surface of the support,
the watch strap further includes a fastening block coupled to the pair of flanges between the pair of flanges, and
the fastening block includes a pair of connection terminals electrically connecting the pair of input terminals and the all-solid-state battery to each other.

17. The smart watch of claim 16, wherein
the pair of connection terminals is located inside the fastening block,
each of the pair of connection terminals includes a first end and a second end,
the first end of one of the pair of connection terminals is exposed to one side of the fastening block,
the first end of the other of the pair of connection terminals is exposed to another side of the fastening block, and
both of the second ends of the pair of connection terminals are exposed to an inner surface of the fastening block facing the support to be connected to the pair of input terminals.

18. The smart watch of claim 17, wherein
at least one of the plurality of hinge coupling units is pivotably coupled to one of the first and second electrode terminal units and one of the first ends of the pair of connection terminals to electrically connect the one of the first and second electrode terminal units and the one of the first end to each other.

19. The smart watch of claim 15, wherein
the plurality of flanges includes a central flange and two side flanges,
the pair of input terminals is located on both sides of the central flange, and
two of the plurality of hinge coupling units are coupled to the central flange and the side flanges in recess portions between the central flange and the side flanges.

20. The smart watch of claim 19, wherein
each of the two hinge coupling units is coupled to the electrode terminal unit of one of the plurality of strap blocks and one of the input terminals to electrically connect the electrode terminal unit and the input terminal to each other.
